(19) United States
(12) Patent Application Publication
(10) Pub. No.: US 2017/0062161 A1
(43) Pub. Date: Mar. 2, 2017

(54) TEMPERATURE SWITCH

(71) Applicant: Uchiya Thermostat Co., Ltd., Saitama-ken (JP)

(72) Inventor: Hideaki Takeda, Saitama (JP)

(21) Appl. No.: 15/120,349

(22) PCT Filed: Oct. 9, 2014
(86) PCT No.: PCT/JP2014/077059

§ 371 Date: Aug. 19, 2016

(30) Foreign Application Priority Data
Feb. 25, 2014 (JP) 2014-033728

(51) Int. Cl. H01H 37/52

(52) U.S. Cl. CPC H01H 37/52; H01H 2205/002

(57) ABSTRACT

A movable flat surface portion, which rises in conjunction with the upward movement of a facing surface, first causes an edge of the movable flat surface portion to abut a flat surface portion, second brings an entirety of a surface of the movable flat surface portion into intimate contact with the fixed flat surface portion as a result of the movable flat surface portion acting against elastic resistance thereof in accordance with upward inertia, third forms, in accordance with a restoring force resulting from the elastic resistance thereof, a gap in the intimate contact with the fixed flat surface portion in a manner such that the forming of the gap starts with an end side continuous with the end of the facing surface, and fourth stabilizes a position shape such that the edge of the movable flat surface portion is a portion that ultimately comes into contact with the fixed flat surface portion.

### TECHNICAL FIELD

The present invention relates to a temperature switch and, more particularly, to a temperature switch that includes a movable plate, the movable plate featuring a high current-interruption performance, being capable of readily returning to a conduction state, and having contacts with a long service life.

### BACKGROUND

Conventionally, a temperature switch has been proposed wherein a bimetallic element that serves as a thermally actuated element is integrated with a movable plate of a metal elastic body that includes a movable contact at a position facing a fixed contact, and an inverting behavior of the bimetallic element responding to an ambient temperature inversion-drives the movable plate to a position at which the movable contact comes into contact with the fixed contact or a position at which the movable contact is separated from the fixed contact, thereby interrupting or connecting a current. (See, for example, Japanese Laid-open Patent Publication No. 2001-351490.)

In the meantime, when a movable plate mounted with contacts is inversion-driven by a bimetallic element, vibrations remain at an edge provided with a movable contact after a current interruption operation has been performed, because the movable plate is a plate-like member having a flat spring characteristic. The vibrations cause an arc to occur intermittently in response to current interruption.

There would be no problem if an arc occurred only once and disappeared. However, when an arc occurs intermittently, even interruption of a small current melts members near a contact because the arc has a high energy, thereby leading to welding and other faults.

In particular, when an arc occurs intermittently after a large current has been interrupted, the enormous energy could possibly destroy a housing for a temperature switch.

To avoid such a fault, or to suppress vibrations at an edge of a movable plate at which a movable plate is provided, in Japanese Laid-open Patent Publication No. 2001-351490, when a contact after current interruption generates heat abnormally due to unstable contacting or an overcurrent, the edge of the movable plate that has been displaced upward is bonded and fixed to an upper inner surface of a case so as to safely interrupt the current.

However, in a technique described in Japanese Laid-open Patent Publication No. 2001-351490, an edge of a movable plate is bonded and fixed to an upper inner surface of a case when a contact generates heat abnormally, and hence the contact cannot return to the original state even after the temperature decreases.

Hence, when a contact generates heat abnormally, a temperature switch needs to be replaced with a new one in addition to eliminating an abnormality in an electric circuit to which the temperature switch is connected. That is, the burden of replacement is caused, and, in addition, such a technique is uneconomical because the temperature switch is abolished, not reused.

Objects of the present invention are to solve the conventional problem described above and to provide a temperature switch that includes a movable plate, the movable plate featuring a high current-interruption performance, being capable of readily returning to a conduction state, and having a contact with a long service life.

### DISCLOSURE OF THE INVENTION

A temperature switch of the invention includes a housing that includes an inner top surface having a fixed flat surface portion formed at one end of the inner top surface; a fixed contact located at an inner lower surface facing the fixed flat surface portion of the housing, and connected to an inner end of a first connection terminal extending out of the housing; a thermally actuated element that warps in one direction at a temperature lower than a predetermined temperature and that inverts the direction of the warp at the predetermined temperature or higher; and a movable plate that includes a plate-like body consisting of a metal elastic plate to which the thermally actuated element is attached, wherein one end of the plate-like body in a longitudinal direction is fixed to a support of the housing, an inner end of a second connection terminal extending out of the housing is connected to the one end, the movable plate holds a movable contact at a facing surface of another end of the longitudinal direction that faces the fixed contact, and the movable plate includes a movable flat surface portion continuous with an end of the facing surface, wherein the movable plate brings the movable contact into contact with the fixed contact by pressure at a temperature lower than the predetermined temperature, so as to establish an electric connection between the first and second connection terminals, wherein, at the moment the predetermined temperature or higher is achieved, the thermally actuated element inverts the direction of the warp, so as to perform displacement drive to move the facing surface of the movable plate upward, in accordance with the upward movement, the facing surface separates the movable contact from the fixed contact so as to interrupt the electric connection between the first and second connection terminals, and the movable flat surface portion, which rises in conjunction with the upward movement of the facing surface, first causes an edge of the movable flat surface portion to abut the fixed flat surface portion, second brings an entirety of a surface of the movable flat surface portion into intimate contact with the fixed flat surface portion as a result of the movable flat surface portion acting against elastic resistance thereof in accordance with upward inertia, third forms, in accordance with a restoring force resulting from the elastic resistance thereof, a gap in the intimate contact with the fixed flat surface portion in a manner such that the forming of the gap starts with an end side continuous with the end of the facing surface, and fourth stabilizes a position shape such that the edge of the movable flat surface portion is a portion that ultimately comes into contact with the fixed flat surface portion.

In the temperature switch, the movable flat surface portion is, for example, folded at a portion continuous with the end of the facing surface toward a surface opposite to the facing surface, and extends in the one end direction of the longitudinal direction of the plate-like body; the movable flat surface portion has, for example, a mountain-fold angle ranging from a portion continuous with the end of the facing surface, and is formed as an extension of the plate-like body in the longitudinal direction.

In the temperature switch, the movable plate includes, for example, one or more notches at a neighbor continuous with the movable flat surface portion of the plate-like body, and includes, for example, one or more hollows on the movable flat surface portion that have a suction function with respect to the fixed flat surface portion.

In the temperature switch, as an example, one of the movable flat surface portion and the fixed flat surface portion may have a magnetic property, and the other may be a ferromagnetic body. As another example, elastomer with rubber elasticity may be applied to one of or both of the movable flat surface portion and the fixed flat surface portion.

In the temperature switch, the thermally actuated element is attached to, for example, the top surface of the plate-like body of the movable plate.

In the temperature switch, as an example, the movable plate may be configured in a manner such that one end of the plate-like body in the longitudinal direction is bonded and fixed to the support of the housing. As another example, the movable plate may be configured in a manner such that, for position fixing, one end of the plate-like body in the longitudinal direction is held between upper and lower supports of the housing in a sandwiching manner.

As described above, the present invention enables providing a temperature switch that includes a movable plate, the movable plate featuring a high current-interruption performance, being capable of readily returning to a conduction state, and having contacts with a long service life.

### BRIEF DESCRIPTION OF THE DRAWINGS

FIG. 1A is a sectional side view of a temperature switch in accordance with embodiment 1;

FIG. 1B is a partial enlargement of FIG. 1A;

FIG. 1C is a perspective view illustrating only a movable plate from FIGS. 1A and 1B;

FIG. 1D is a perspective view illustrating an internal structure from FIG. 1A;

FIG. 2A illustrates an operation state of a temperature switch in accordance with embodiment 1 (example 1);

FIG. 2B illustrates an operation state of a temperature switch in accordance with embodiment 1 (example 2);

FIG. 2C illustrates an operation state of a temperature switch in accordance with embodiment 1 (example 3);

FIG. 2D illustrates an operation state of a temperature switch in accordance with embodiment 1 (example 4);

FIG. 3 is a sectional view of a temperature switch in accordance with a variation of embodiment 1;

FIG. 4A is a sectional side view illustrating the configuration of a temperature switch in accordance with embodiment 2;

FIG. 4B is a perspective view illustrating only an internal structure from FIG. 4A;

FIG. 4C is a plane view illustrating only a bimetallic element and a movable plate from FIG. 4B;

FIG. 5A illustrates an operation state of a temperature switch in accordance with embodiment 2 (example 1);

FIG. 5B illustrates an operation state of a temperature switch in accordance with embodiment 2 (example 2);

FIG. 5C illustrates an operation state of a temperature switch in accordance with embodiment 2 (example 3);

FIG. 5D illustrates an operation state of a temperature switch in accordance with embodiment 2 (example 4); and

FIG. 6 is a sectional side view illustrating a state achieved when two contacts open in the configuration of a temperature switch in accordance with embodiment 3.

### EXPLANATION OF THE CODES

1: Temperature switch
2: Housing
3: Fixed flat surface portion
4: Fixed contact
5: Conducting wire
6: First connection terminal
7: Movable plate
8: Plate-like body
   8a: One end in longitudinal direction
   8b: Movable contact holder
   8c: Folded portion
   8d: Bent portion
9: Support
11: Second connection terminal
12: Movable contact
13: Falculate holder
14: Movable flat surface portion
   14a: Point of action
15: Bimetallic element
   15a: One end
   15b: Another end
16: Lower support
   16a: Sandwiching portion
   16b: Convex fulcrum
17: Upper support
18: Column
19, 21, 22: Rectangular hole
24: Recess
25: Temperature switch
26: Housing
27: Connection hole
28: First terminal
29: Connection hole
31: Second terminal
32: Convex fulcrum
33: Support
34: Conductive portion
   34a: Inner terminal
35: Conductive member
   35a: Inner terminal
36: Fixed contact
37: Movable plate
38: Plate-like body
   38a: Rear-end fixed portion
   38b: Movable contact holder
39: Movable flat surface portion
41: Movable contact
42: Bimetallic element
43, 44: Falculate holder
45: Lateral limitation lug
46: Fixed flat surface portion
47: Notch
50: Temperature switch
51: Metal-plate flat surface portion
   51a: Extension edge

### BEST MODE FOR CARRYING OUT THE INVENTION

### Embodiment 1

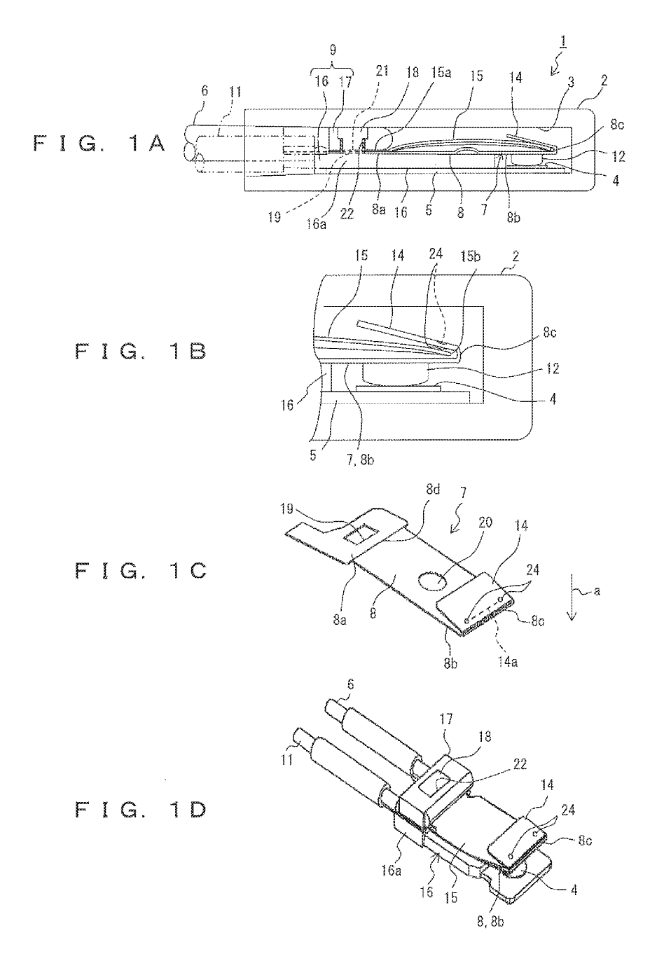

FIG. 1A is a sectional side view of a temperature switch in accordance with embodiment 1. FIG. 1B is a partial enlargement of FIG. 1A. FIG. 1C is a perspective view illustrating only a movable plate from FIGS. 1A and 1B. FIG. 1D is a perspective view illustrating an internal structure from FIG. 1A. FIG. 1A depicts the temperature switch in an ordinary (conduction) state.

As illustrated in FIG. 1A, a temperature switch 1 in accordance with the present embodiment includes a housing 2. A fixed flat surface portion 3 is formed at one end of an inner top surface of the housing 2, the fixed flat surface portion 3 being smoother than the other surfaces. A fixed contact 4 is provided at an inner lower surface facing the fixed flat surface portion 3.

An inner end of a first connection terminal 6 extending out of the housing 2 is connected to the fixed contact 4 by a conducting wire 5.

A movable plate 7 is located at the center of the inside of the housing 2, the movable plate 7 extending from one end of a longitudinal direction (horizontal direction in the figure) to the other. The movable plate 7 includes one end 8a of a plate-like body 8 in the longitudinal direction (an end on the left side of the figure) consisting of a metal elastic plate, the one end 8a being fixed to a support 9 of the housing 2.

An inner end of a second connection terminal 11 extending out of the housing 2 is connected to the one end 8a of the plate-like body 8. At another end of the plate-like body 8 (an end on the right side of the figure), a movable contact 12 is adhered and fixed to a lower surface of a movable contact holder 8b facing the fixed contact 4.

The plate-like body 8 has a movable flat surface portion 14 formed thereon, the movable flat surface portion 14 being continuous with an end of the movable contact holder 8b that faces the fixed contact 4 and that holds the movable contact 12. The movable flat surface portion 14 is folded, toward a surface opposite to the movable contact holder 8b, at the folded portion 8C continuous with an end of the movable contact holder 8b, and extends in the direction of the one end 8a of the plate-like body 8.

A bimetallic element 15 that serves as a thermally actuated element is attached to a top surface of the plate-like body 8 of the movable plate 7. One end 15a of the bimetallic element 15 overlaps the one end 8a of the plate-like body 8 of the movable plate 7 and is held by the support 9, and another end 15b of the bimetallic element 15 is located inside relative to a bent portion 8c at a basal portion of the movable flat surface portion 14, with the result that the two ends of the bimetallic element 15 engage with the movable plate 7.

The support 9 consists of a lower support 16 and an upper support 17. The lower support 16 is provided with a column 18 at a sandwiching portion 16a that holds the one end 8a of the plate-like body 8 of the movable plate 7 and the one end 15a of the bimetallic element 15 together with the upper support 17 in a sandwiching manner such that the one end 8a and the one end 15a overlap each other.

The column 18 positions the movable plate 7 and the bimetallic element 15 in a manner such that the movable plate 7 and the bimetallic element 15 pass through a rectangular hole 19 formed at the one end 8a of the movable plate 7, a rectangular hole 21 formed at the one end 15a of the bimetallic element 15, and a rectangular hole 22 formed at the upper support 17.

As illustrated in FIG. 1C, the plate-like body 8 of the movable plate 7 is bent downward at a bent portion 8d for the one end 8a. As a result, the movable contact 12 (this cannot be seen in FIGS. 1C and 1D because it is behind the movable contact holder 8b) held at the other end may be brought into contact with the fixed contact 4 using an appropriate pressing force indicated by arrow a during the conduction state depicted in FIG. 1A.

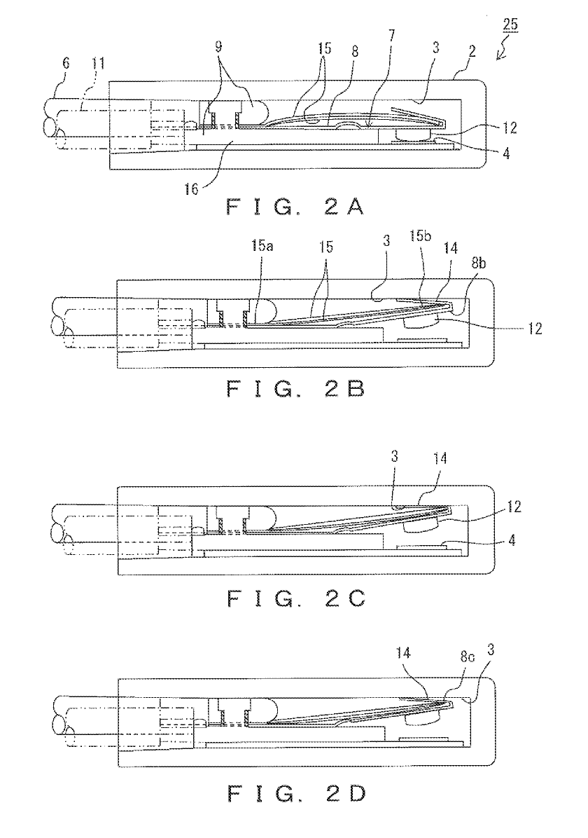

FIGS. 2A-2D illustrate operation states of the temperature switch 1. FIG. 2A depicts again the configuration of the initial state illustrated in FIG. 1A. In FIGS. 2A-2D, only the parts required for the description are given like reference marks to those depicted in FIGS. 1A-1D.

In FIG. 2A, the temperature of the inside of the temperature switch 1 is lower than a predetermined temperature (ordinary temperature). At this temperature, the bimetallic element 15 does not act on the movable plate 7.

Accordingly, since the plate-like body 8 of the movable plate 7 is bent downward at the bent portion 8d for the one end 8a as described above with reference to FIG. 1C, when the two contacts are closed with the movable contact 12 pressing the fixed contact 4, the plate-like body 8 is exposed to a force pushing back the downward bend, the force being applied by the fixed contact 4.

Owing to elasticity, the plate-like body 8 has a spring characteristic resisting the pushing-back force from the fixed contact 4, thereby steadily bringing the movable contact 12 into intimate contact with the fixed contact 4.

In this state, electricity from an external electric path establishes an electric connection between the first connection terminal 6 and the second connection terminal 11, the first connection terminal 6 and the second connection terminal 11 having external ends connected to the external electric path and internal ends connected to the fixed contact 4 and the movable contact 12.

When the temperature of the inside of the housing 2 has become equal to or higher than the predetermined temperature, the bimetallic element 15 inverts, as depicted in FIG. 2B, the direction of the warp in FIG. 2A, and the other end 15b is flipped up with the one end 15a, which has been supported by the support 9, serving as a fulcrum.

The flipping-up of the other end 15b acts on a point of action 14a at the basal portion of the movable flat surface portion 14 of the movable plate 7 (see FIG. 1C), thereby raising the movable contact holder 8b of the plate-like body 8, the movable flat surface portion 14, and the movable contact 12 in a flipping-up manner.

The upward movement of the movable contact holder 8b separates the movable contact 12 from the fixed contact 4, thereby interrupting the electric connection between the first connection terminal 6 and the second connection terminal 11. Simultaneously, an edge of the movable flat surface portion 14 of the movable plate 7, which has been flipped up, abuts the fixed flat surface portion 3, as illustrated in FIG. 2B.

In the absence of the movable flat surface portion 14 at the end of the movable plate 7 at which the movable contact 12 is present, the end of the movable plate 7 that has been flipped up vertically vibrates in reaction to the elasticity, and the movable contact 12 may come into contact with the fixed contact 4 again, thereby causing an arc to occur intermittently, with the result that the high temperature energy could cause failures such as melting or welding of surrounding components.

However, when the movable flat surface portion 14 is provided as in the case of the present embodiment, the movable flat surface portion 14 absorbs impact from the flipping-up of the movable plate 7 owing to the elastic resistance of the movable flat surface portion 14 during the period extending from the moment the edge of the movable flat surface portion 14 abuts the fixed flat surface portion 3 to the moment the entirety of the movable flat surface portion 14 comes into intimate contact with the fixed flat surface portion 3, as depicted in FIG. 2C.

Absorbing the impact from the flipping-up weakens the momentum of springback toward the fixed contact 4 that could occur in reaction to the impact from the flipping-up, the intimate contact between the entirety of the surface of the movable flat surface portion 14 and the fixed flat surface portion 3 (FIG. 2C) is smoothly achieved without springback, and the movable contact 12 is separated from the fixed contact 4 by a greatest distance for a short time.

The short time may be, for example, 0.1 second. In particular, as long as the movable contact 12 can be separated from the fixed contact 4 by the longest distance for 0.1 second or longer, the arc between the contacts can be effectively limited to the initial occurrence, i.e., the arc, which could occur intermittently, can be completely interrupted after it occurs once.

The intimate contact between the movable flat surface portion 14 and the fixed flat surface portion 3 is one temporarily caused by the inertia of the flipping-up of the bimetallic element 15 and the movable plate 7.

Accordingly, subsequently, the folded portion 8c of the movable contact holder 8b is separated from the fixed flat surface portion 3, as depicted in FIG. 2D, due to a restoring force resulting from the elastic resistance of the movable flat surface portion 14 and the force of returning to a balanced position that occurs in response to the displacement caused by the bimetallic element 15 continuously raising the movable plate 7.

Finally, the edge of the movable flat surface portion 14 comes into contact with the fixed flat surface portion 3, and the entirety of the configuration is stabilized at the balanced position. In other words, the final stopping position of the movable plate 7 is one such that the elastic force of the movable plate 7 and the inverting force of the bimetallic element 15 are balanced. At the moment the stopping position is balanced, the arc that occurred only once in current interruption has already vanished.

As described above, in the present embodiment, for a short time up to a moment at which an arc that occurs in interrupting a current vanishes, the contacts can be separated by the longest distance, and the movable contact can be prevented from vibrating in reaction to the interrupting, so that the arc can be completely interrupted after it occurs once, thereby improving the interruption performance and achieving long service lives for the contacts.

In the present embodiment, the flat surface portion 14, which is formed at the edge of the movable plate 7, i.e., the edge of the plate-like body 8, and which is an important element for absorbing the impact from the springback of the bimetallic element 15, is folded at the edge of the plate-like body 8 into a U-shape, thereby achieving the advantages that the conventional length of the movable plate 7, i.e., the length without a folded portion, can be maintained and that the interruption performance can be improved with the temperature switch 1 staying small.

In the temperature switch 1 of the present embodiment, elastomer with rubber elasticity may be applied to one of or both of the movable flat surface portion 14 and the fixed flat surface portion 3, although this is unclear from FIGS. 1A-1D and FIGS. 2A-2D.

Accordingly, when the entirety of the surface of the movable flat surface portion 14, as depicted in FIG. 2C, comes into intimate contact with the fixed flat surface portion 3 owing to the inertia of the flipping-up, by acting against the elastic resistance of the movable flat surface portion 14, there is substantially no space for a gap between the surfaces into which air would enter, thereby making the intimate contact more stable.

The more stable intimate contact delays the occurrence of separation of the fixed flat surface portion 3 from the end side (the folded portion 8c), and the movable contact 12 can be separated from the fixed contact 4 by the longest distance for a longer time, e.g., for 0.1 second or longer.

When the elastomer is applied to only the fixed flat surface portion 3, a plurality of recesses 24 may be formed, as depicted in FIGS. 1C-1D, on the top surface of the movable flat surface portion 14 such that the recesses 24 can provide a suction function while the entirety of the surface of the movable flat surface portion 14 and the fixed flat surface portion 3 are in intimate contact with each other.

The suction function can also make the intimate contact more stable, thereby delaying the occurrence of separation between the folded portion 8c and the fixed flat surface portion 3. The number of recesses 24 to be formed and their positions may be arbitrarily determined to desirably adjust the delay of the separation.

The recesses 24 are not limited to the suction function. The size and number of recesses 24 may be appropriately determined to increase the stiffness of the movable flat surface portion 14, thereby adjusting the elastic resistance of the movable flat surface portion 14.

When the movable flat surface portion 14 is, as depicted in FIG. 2C, in intimate contact with the fixed flat surface portion 3, fluid viscosity generated when air is sent out of the space between the movable flat surface portion 14 and the fixed flat surface portion 3 acts on the movable flat surface portion 14, thereby reinforcing the elastic resistance of the movable flat surface portion 14, which absorbs the impact from the flip-up of the movable plate 7.

Conversely, when the movable flat surface portion 14 is, as depicted in FIG. 2D, partly separated from the fixed flat surface portion 3, the fluid viscosity of air entering the space between the movable flat surface portion 14 and the fixed flat surface portion 3 delays the elimination of the intimate contact with the entirety of the surface of the movable flat surface portion 14.

### Variation of Embodiment 1

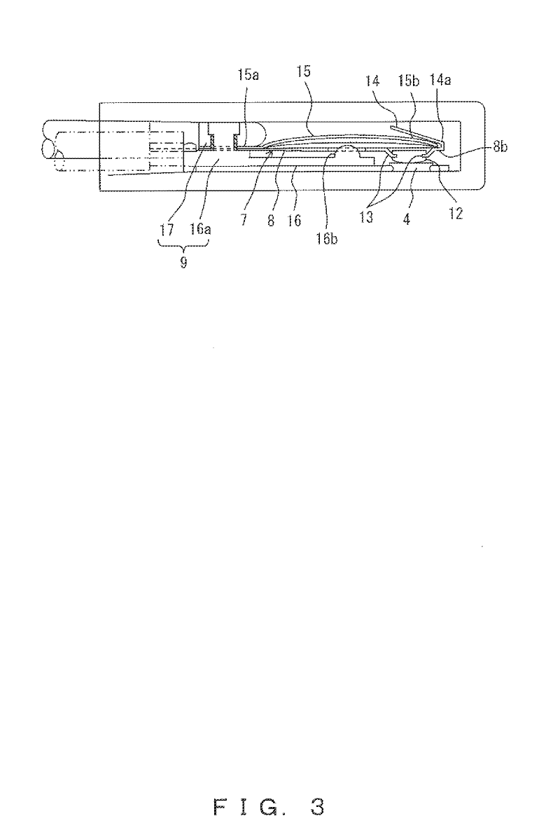

FIG. 3 is a sectional view of a temperature switch in accordance with a variation of embodiment 1. In FIG. 3, like components or functional parts are given like reference marks to those depicted in FIGS. 1A-1D and FIGS. 2A-2D.

As depicted in FIG. 3, the movable contact 12 is held by two falculate holders 13 in a manner such that the falculate holders 13 engage with the two sides of the movable contact 12, the falculate holders 13 facing each other and being formed of a slit, a slit rising portion, and a rising-portion-edge bent portion at the movable contact holder 8b of the plate-like body 8 of the movable plate 7.

In comparison with FIGS. 1A, 1B, and 1D and FIGS. 2A-2D, the shape of the tabular lower support 16 is different in addition to the column 18. The portion of the lower support 16 of this example that is closer to the fixed contact 4 than the sandwiching portion 16a is low-lying due to a step-like shape, and a convex fulcrum 16b is formed at a position on the top surface of the end of the lower support 16 that is close to the fixed contact 4, the position corresponding to the center of the bimetallic element 15.

The edge of the convex fulcrum 16b passes through a circular hole 20 formed at the plate-like body 8 of the movable plate 7, which is depicted in FIG. 1C without descriptions, so as to protrude above the circular hole 20 at all times.

Accordingly, when the direction of the warp of the bimetallic element 15, which warps, as depicted in FIG. 3, in one direction (downward) at a temperature lower than a predetermined temperature, is inverted at the predetermined temperature or higher, the other end 15b of the bimetallic element 15 is flipped up with the one end 15a, which is supported by the support 9, serving as a fixed end of a seesaw, and with the central position, which is under-supported by the convex fulcrum 16b, serving as the fulcrum of the seesaw.

In this case, the flipping-up of the other end 15b of the bimetallic element 15 also acts on the point of action 14a at the basal portion of the movable flat surface portion 14 of the movable plate 7, thereby raising the movable contact holder 8b, the movable contact 12, and the movable flat surface portion 14, i.e., elements facing the fixed contact 4 of the plate-like body 8, in a flipping-up manner. The following operations are similar to those described above with reference to FIGS. 2B-2D.

### Embodiment 2

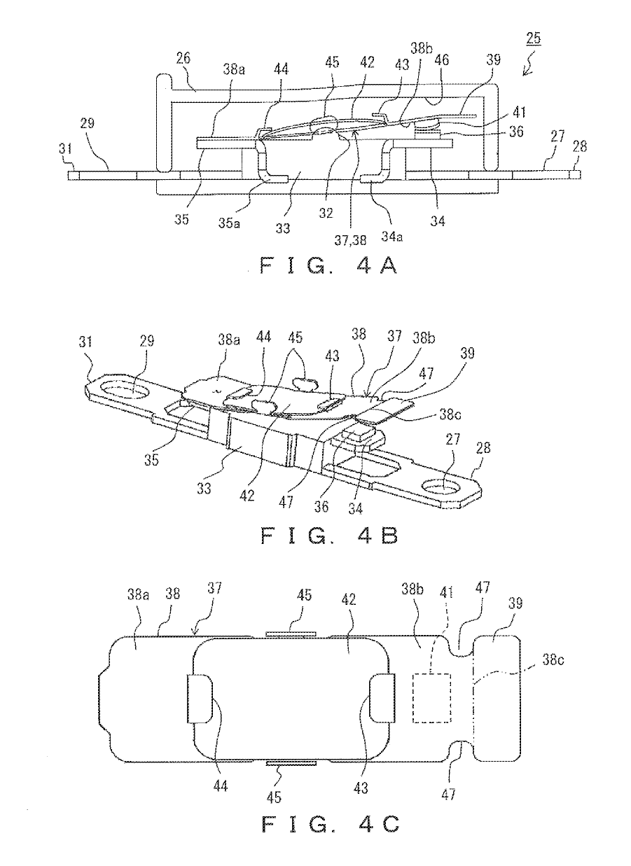

FIG. 4A is a sectional side view illustrating the configuration of a temperature switch in accordance with embodiment 2. FIG. 4B is a perspective view illustrating only an internal structure from FIG. 4A. FIG. 4C is a plane view illustrating only a bimetallic element and a movable plate from FIG. 4B. For the sake of description, FIG. 4B depicts a state achieved when a movable contact (this cannot be seen in the figure because it is behind the movable plate) is separated from a fixed contact.

As depicted in FIGS. 4A-4C, a temperature switch 25 of this example includes a box-shaped housing 26. A first terminal 28 and a second terminal 31 extend out of the respective lower portions of the two ends of the housing 26 in the longitudinal direction (horizontal direction in FIG. 4), the first terminal 28 and the second terminal 31 respectively having formed therethrough a connection hole 27 and a connection hole 29 each intended to establish a connection to an external electric path.

At the center of the inside of the housing 26, a resinous support 33 is fixed to the bottom of the housing 26, wherein a convex fulcrum 32 is formed at the center of the upper portion of the support 33. The first terminal 28 and the second terminal 31, each of which includes an inner end drawn into the housing 26, are held through welding in a manner such that the inner ends are buried in the support 33.

The holder 33 holds an inner terminal 34a of a conductive portion 34 and an inner terminal 35a of a conductive portion 35, the conductive portion 34 and the conductive portion 35 each horizontally extending from an end of the upper portion of the holder 33 in the longitudinal direction. The inner terminals 34a and 35a are drawn from horizontal portions perpendicularly into the holder 33 and fixed in a manner such that they are buried in the holder 33.

A fixed contact 36 is fixed to the top surface of the conductive portion 34. In the holder 33, the inner end of the first terminal 28 is connected to the inner terminal 34a of the conductive portion 34. In the holder 33, the inner end of the second terminal 31 is connected to the inner terminal 35a of the conductive portion 35.

A movable plate 37 extends from an end of the conductive portion 35 to a position beyond an end of the conductive portion 34. The movable plate 37 includes a plate-like body 38 consisting of a metal elastic plate, and is fixed by bonding a rear-end fixed portion 38a of the plate-like body 38 that faces the conductive portion 35 to the conductive portion 35.

A movable contact holder 38b and a movable flat surface portion 39 are formed at a front end of the movable plate 37 opposite from the rear-end fixed portion 38a. The movable flat surface portion 39 forms a mountain-fold angle at a boundary 38c continuous with an end of the movable contact holder 38b, and is formed as a longitudinal-direction extension of the plate-like body 38.

A movable contact 41 is adhered to the lower surface of the movable contact holder 38b. The movable contact 41 cannot be seen in FIG. 4B because it is behind the movable contact holder 38b. The fixed contact 36 and the movable contact 41 of the present embodiment are rectangle-shaped, as depicted in FIGS. 4B and 4C, unlike the case in example 1, in which they are circle-shaped.

Although not particularly illustrated, a method of producing the contacts includes extending the rectangular contact material in a longitudinal direction or a short direction and cutting the extended rectangular contact material in conformity with a desired contact size. The contact material includes a clad material of an antioxidant metal such as silver to serve as a contact surface, and a metal such as copper to serve as a base to be held by the contact holder.

A bimetallic element 42 is disposed on the top surface of the plate-like body 38 of the movable plate 37. The bimetallic element 42 is held in a manner such that two ends of the bimetallic element 42 in the longitudinal direction are pressed by two falculate holders 43 and 44 that face each other and that are formed of a slit of the plate-like body 38, a slit rising portion, and a rising-portion-edge bent portion.

Lateral limitation lugs 45 and 45 each installed upward on either side of the plate-like body 38 of the movable plate 37 prevent the bimetallic element 42 from moving in a lateral direction.

A fixed flat surface portion 46 is formed on the portion of the inner top surface of the housing 26 that corresponds to the top surface of the movable flat surface portion 39, the fixed flat surface portion 46 being smoother than the other portions.

The plate-like body 38 includes one or more notches 47 at a neighbor continuous with the movable flat surface portion 39, i.e., at a position close to the boundary 38c between the plate-like body 38 and the movable flat surface portion 39.

Appropriately determining the number, size, and depth of notches 47 allows the elasticity of the movable flat surface portion 39 to be adjusted in a contact opening operation for the temperature switch 25, which will be described hereinafter.

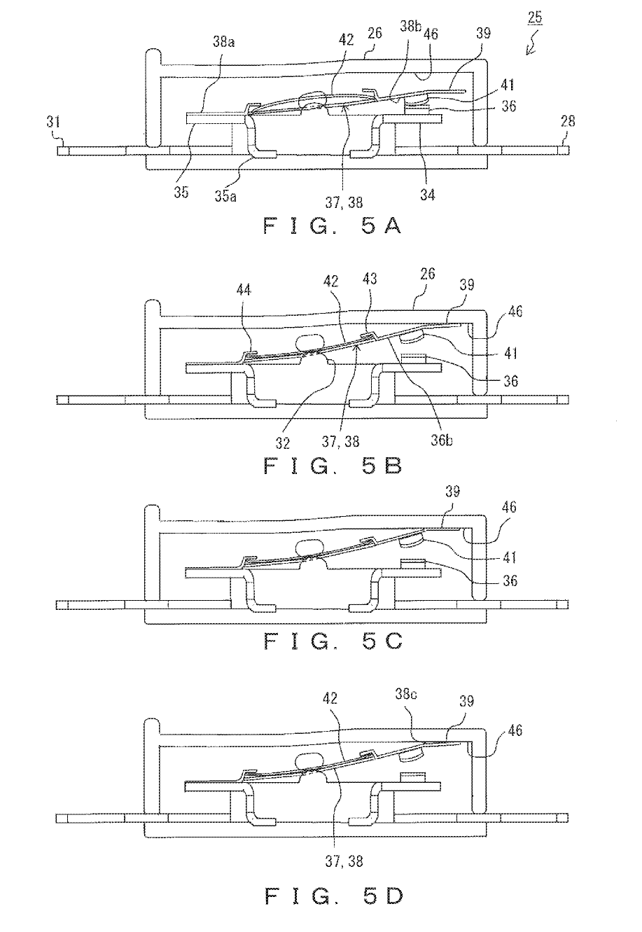

FIGS. 5A-5D illustrate operation states of the temperature switch 25. For description of operations, FIG. 5A depicts the configuration of FIG. 4A. In FIGS. 5A-5D, only the parts required for the description are given like reference marks to those depicted in FIGS. 4A-4C.

In FIG. 5A, the temperature of the inside of the temperature switch 25 is lower than a predetermined temperature (ordinary temperature). At this temperature, the bimetallic element 42 does not act on the movable plate 37 (plate-like body 38) at all.

Accordingly, the plate-like body 38 of the movable plate 37 includes a flat surface portion extending from the bonded portion 38a, which is bonded to the inner terminal 35 of the conductive member 35, to the end of the conductive member 34, i.e., the surface facing the fixed contact 36.

However, at the portion facing the inner terminal 34, a space is formed between the surface of the inner terminal 34 and the facing surface 38b of the plate-like body 38, the space having a height equal to the sum of the height of the fixed contact 36 and the height of the movable contact 41.

The facing surface 38b of the plate-like body 38 rises by the height of the space, and hence the return resistance of the plate-like body 38, i.e., an elastic body, steadily brings the movable contact 41 into intimate contact with the fixed contact 36.

In this state, electricity from an external electric path establishes an electric connection between the first terminal 28 and the second terminal 31, whose external ends are connected to the external electric path and whose internal ends are connected to the fixed contact 36 and the movable contact 41.

When the temperature of the inside of the housing 26 is equal to or higher than the predetermined temperature, the bimetallic element 42 inverts, as depicted in FIG. 5B, the direction of the warp in FIG. 5A. As a result, the bimetallic element 42 flips up the end on the falculate-holder-43 side with the falculate holder 44 serving as a fixed fulcrum and the convex fulcrum 32 serving as a central action fulcrum.

The flipping-up of the end on the falculate-holder-43 side causes the falculate holder 43 to flip up the facing surface 38b of the movable plate 37, i.e., a surface facing the fixed contact 36, and to raise the movable flat surface portion 39 continuous with the facing surface 38b in a flipping-up manner.

The flipping-up of the facing surface 38b separates the movable contact 41 from the fixed contact 36, thereby interrupting the electric connection between the first terminal 28 and the second terminal 31.

Meanwhile, the flipping-up of the movable flat surface portion 39 of the movable plate 37 causes the edge to abut the fixed flat surface portion 46 of the inner top surface of the housing 26, as depicted in FIG. 5B.

Subsequently, in the absence of the movable flat surface portion 39 that is an extension of the end of the movable plate 37 at which the movable contact 41 is present, the end of the movable plate 37 that has been flipped up, i.e., the movable contact 41, vertically vibrates in reaction to the elasticity, and the movable contact 41 may come into contact with the fixed contact 36 again, thereby causing an arc to occur intermittently, with the result that the high temperature energy could cause failures such as melting of surrounding components.

However, in the present embodiment, owing to the elastic resistance of the movable flat surface portion 39 (a corresponding feature is also provided in embodiment 1), the movable flat surface portion 39 also absorbs impact from the flipping-up of the movable plate 37 during the period extending from the moment the edge of the movable flat surface portion 39 abuts the fixed flat surface portion 46 to the moment the entirety of the movable flat surface portion 39 depicted in FIG. 5C comes into intimate contact with the fixed flat surface portion 46.

Absorbing the impact from the flipping-up weakens the momentum of springback toward the fixed contact 36 that could occur in reaction to the impact from the flipping-up, the intimate contact between the entirety of the surface of the movable flat surface portion 39 and the fixed flat surface portion 46 (FIG. 5C) is smoothly achieved without springback, and the movable contact 41 is separated from the fixed contact 36 by a longest distance for a short time.

Even in a case where the movable contact 41 is separated from the fixed contact 36 by the longest distance as depicted in FIG. 5C for a short time of, for example, 0.1 second, the arc between the contacts can be limited to the initial occurrence, i.e., the arc, which could occur intermittently, can be completely interrupted after it occurs once.

The intimate contact between the movable flat surface portion 39 and the fixed flat surface portion 46 is one temporarily caused by the inertia of the flipping-up of the bimetallic element 42 and the movable plate 37. Hence, after about 0.1 second, which is described above, has elapsed, the elastic restoring force of the movable flat surface portion 39 and a balance force between the bimetallic element 42 and the movable plate 37 separate portions of the movable flat surface portion 39 close to the boundary 38c from the fixed flat surface portion 46, as depicted in FIG. 5D.

Finally, the edge of the movable flat surface portion 39 comes into contact with the fixed flat surface portion 46, and the entirety of the configuration is stabilized at the balanced position. At the moment the configuration is stabilized at the balance position, the arc that occurred only once in current interruption has already vanished.

As described above, in the present embodiment, for a short time up to a moment an arc that occurred in interrupting a current vanishes, the contacts can be separated by the longest distance, and the movable contact can be prevented from vibrating in reaction to the interrupting, thereby improving the interruption performance and achieving long service lives for the contacts.

In the present embodiment, the movable flat surface portion 39 formed at the edge of the movable plate 37, i.e., at the edge of the plate-like body 38, is formed by extending the plate-like body 38 in the longitudinal direction. Hence, the movable plate 37 is long, and the temperature switch 25 becomes slightly large. However, the present embodiment has the advantage that the shaping can be more readily performed owing to the mountain-fold angle than in the case of embodiment 1, in which the folding technique is used.

In the temperature switch 25 of the present embodiment, elastomer may be applied to one of or both of the movable flat surface portion and the fixed flat surface portion.

### Embodiment 3

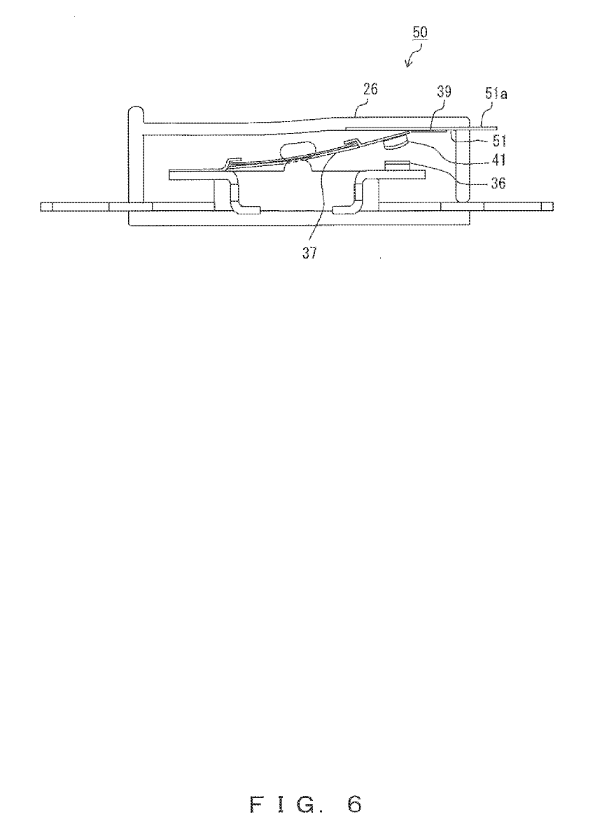

FIG. 6 is a sectional side view illustrating a state achieved when two contacts open in the configuration of a temperature switch in accordance with embodiment 3. A temperature switch 50 in accordance with embodiment 3 depicted in FIG. 6 includes components that are identical with those depicted in FIGS. 4A-4C and FIGS. 5A-5D; in FIG. 6, reference marks are assigned to only the components required for description.

The temperature switch 50 of embodiment 3 depicted in FIG. 6 is different from the temperature switch 25 of embodiment 2 depicted in FIGS. 4A-4C and FIGS. 5A-5D in the sense that the temperature switch 50 includes a metal-plate flat surface portion 51 instead of the fixed flat surface portion 46, which is formed at the left end of the inner top surface of the housing 26 in the longitudinal direction.

In FIG. 6, an extension edge 51a of the metal-plate flat surface portion 51 protrudes out of the housing 26, but the configuration is not necessarily limited to this. In either case, the surface of metal is typically smoother than the surface of resin, which is a material for the housing 26.

As long as at least one of the two flat surfaces is, as described above, a smoother surface like the metal-plate flat surface portion 51, the intimate contact with the movable flat surface portion 39 becomes stronger, thereby separating the movable contact 44 from the fixed contact 36 by the longest distance for a longer time.

Configuring the metal plate of the metal-plate flat surface portion 51 with a magnetized magnetic material and configuring the movable plate 37 and thus the plate-like body 38, i.e., configuring the movable flat surface portion 39, with a ferromagnetic material, e.g., ferritic stainless steel, further makes the intimate contact between the metal-plate flat surface portion 51 and the movable flat surface portion 39 stronger, thereby separating the movable contact 41 from the fixed contact 36 by the longest distance for a still longer time.

Incorporating commutation resistors in parallel between the contacts in combination with the structure described above is effective for the control to decrease the ark occurrence as described above. What is called a PTC element, i.e., a positive character thermistor, that has low resistance may be used as the commutation resistors, and a lower-resistance resistor is more effective.

In this case, a voltage divided by load resistance and the low-resistance resistor parallely connected between the contacts emerges at both ends of each connection portion. The closed contact portion is parallely connected to the low-resistance resistor, but essentially no voltage emerges at either end of the connection portion because the contact is closed.

However, when the contact opens due to an increased ambient temperature or an excessive current, a voltage is generated that depends on the value of resistance of the parallely connected low-resistance resistor. A lower value of resistance leads to less of a voltage drop such that the voltage generated between the contacts can be limited to a low one.

The voltage depends on the relationship between a current and a value of resistance. Hence, limiting the voltage between the contacts to a low one such that an arc is not generated between the contacts enables the interruption without causing an arc, no matter how large the current is.

Subsequent to the interruption operation, the PTC element of the parallel resistor produces heat in response to a flowing current and thus shifts to a high resistance state, thereby allowing passage of essentially no current, and the current interruption operation is completed.

A high voltage generates an arc. Hence, as the distance between opened contacts becomes longer, an ark becomes less likely to occur. Accordingly, using the large current interruption described above, i.e., the large current interruption that relies on a PTC element parallel to the contacts, to maintain a long distance between the contacts, enables current interruption to be performed without generating an arc.

### INDUSTRIAL APPLICABILITY

As described above, the temperature switch of the present invention can be used in all industries that require a temperature switch with a movable plate that features a high current-interruption performance, that is capable of readily returning to a conduction state, and that has a contact with a long service life.

1. A temperature switch comprising:
a housing that includes an inner top surface having a fixed flat surface portion formed at one end of the inner top surface;
a fixed contact located at an inner lower surface facing the fixed flat surface portion of the housing, and connected to an inner end of a first connection terminal extending out of the housing;
a bimetallic element that warps in one direction at a temperature lower than a predetermined temperature and that inverts a direction of the warp at the predetermined temperature or higher; and
a movable plate that includes a plate-like body consisting of a metal elastic plate with which the bimetallic element is combined, wherein one end of the plate-like body in a longitudinal direction is fixed to a support of the housing, an inner end of a second connection terminal extending out of the housing is connected to the one end, the movable plate holds a movable contact at a facing surface of another end of the longitudinal direction that faces the fixed contact, and the movable plate includes a movable flat surface portion continuous with an end of the facing surface, wherein
the movable plate brings the movable contact into contact with the fixed contact by pressure at a temperature lower than the predetermined temperature, so as to establish an electric connection between the first and second connection terminals, wherein
at the moment the predetermined temperature or higher is achieved,
the bimetallic element inverts the direction of the warp, so as to perform displacement drive to move the facing surface of the movable plate upward,
in accordance with the upward movement, the facing surface separates the movable contact from the fixed contact so as to interrupt the electric connection between the first and second connection terminals, and
the movable flat surface portion, which rises in conjunction with the upward movement of the facing surface, first causes an edge of the movable flat surface portion to abut the fixed flat surface portion, second brings an entirety of a surface of the movable flat surface portion into intimate contact with the fixed flat surface portion as a result of the movable flat surface portion acting against elastic resistance thereof in accordance with upward inertia, third forms, in accordance with a restoring force resulting from the elastic resistance thereof, a gap in the intimate contact with the fixed flat surface portion in a manner such that the forming of the gap starts with an end side continuous with the end of the facing surface, and fourth stabilizes a position shape such that the edge of the movable flat surface portion is a portion that ultimately comes into contact with the fixed flat surface portion.

2. The temperature switch according to claim 1, wherein
the movable flat surface portion is folded at a portion continuous with the end of the facing surface toward a surface opposite to the facing surface, and extends in the one end direction of the longitudinal direction of the plate-like body.

3. The temperature switch according to claim 1, wherein
the movable flat surface portion has a mountain-fold angle ranging from a portion continuous with the end of the facing surface, and is formed as an extension of the plate-like body in the longitudinal direction.

4. The temperature switch according to claim 1, wherein
the movable plate includes one or more notches at a neighbor continuous with the movable flat surface portion of the plate-like body.

5. The temperature switch according to claim 1, wherein
the movable plate includes one or more hollows on the movable flat surface portion that have a suction function with respect to the fixed flat surface portion.

6. The temperature switch according to claim 1, wherein
one of the movable flat surface portion and the fixed flat surface portion has a magnetic property, and the other is a ferromagnetic body.

7. The temperature switch according to claim 1, wherein
elastomer with rubber elasticity is applied to one of or both of the movable flat surface portion and the fixed flat surface portion.

8. The temperature switch according to claim 1, wherein
the bimetallic element is attached to a top surface of the plate-like body of the movable plate.

9. The temperature switch according to claim 1, wherein
the movable plate is configured in a manner such that one end of the plate-like body in the longitudinal direction is bonded and fixed to the support of the housing.

10. The temperature switch according to claim 1, wherein
the movable plate is configured in a manner such that, for position fixing, one end of the plate-like body in the longitudinal direction is held between upper and lower supports of the housing in a sandwiching manner.
